(19) United States
(12) Patent Application Publication
(10) Pub. No.: US 2010/0058421 A1
(43) Pub. Date: Mar. 4, 2010

(54) Methods and Apparatus for Updating Digital Television Firmware

(75) Inventors: Steven Hastings, Bolton, MA (US); Scott Pirdy, Westborough, MA (US); Christine Nevin, Shrewsbury, MA (US)

Correspondence Address: CHOATE, HALL & STEWART LLP, TWO INTERNATIONAL PLACE, BOSTON, MA, 02110, US

(73) Assignee: UPDATELOGIC, Southborough, MA (US)

(21) Appl. No.: 12/300,098

(22) PCT Filed: May 9, 2007
(86) PCT No.: PCT/US2007/068574

§ 371 Date: Nov. 9, 2009

Related U.S. Application Data
(60) Provisional application No. 60/746,807, filed on May 9, 2006.

(51) Int. Cl. H04N 7/173

(52) U.S. Cl. 725/116; 725/126; 725/132

(57) ABSTRACT

Systems and methods for using broadcast bandwidth for updating firmware of digital televisions may include identifying a portion of unused bandwidth corresponding to a television station; selecting at least one update module, the update module comprising an update to firmware of a digital television; transmitting, via the unused bandwidth of the television station, the at least one update module; and receiving by a digital television, the at least one update module.

### RELATED APPLICATIONS

The present application claims priority to U.S. Provisional Application 60/746,807 titled “Methods and Apparatus for Updating Digital Television Firmware” filed on May 9, 2007.

### FIELD OF THE INVENTION

The present invention relates to methods and systems related to digital televisions and broadcasting, and specifically methods and systems for efficiently updating digital television firmware and related services.

### BACKGROUND OF THE INVENTION

Modern digital TV devices perform a variety of functions, and may have a firmware component involved in the performance these functions. Firmware may include system level software, operating systems, configuration files, and applications. Updates to digital television firmware may be developed as a result of changes in the market, a desire for new features, or discovery of problems or bugs in existing firmware.

The frequency at which updates are developed for the firmware can be much greater than the rate at which consumers are able or willing to buy new televisions. Thus there exists a need to update firmware on already purchased digital televisions.

One current method for updating firmware includes mailing to purchasers media such as a flash card or memory stick comprising the update. This method may suffer from the drawback of requiring consumers to take affirmative steps to install updates, with the potential result of unreliability and slow distribution. Another current method is to send a technician to consumer homes to install an update. This method may be both costly and cause inconvenience for consumers.

### SUMMARY OF THE INVENTION

The present invention relates to means of delivering digital television firmware update modules over broadcast signals for efficient, reliable delivery of update modules to digital televisions.

In one aspect the present invention relates to methods and systems for increasing the probability that an update module will successfully reach a receiving television. In one embodiment, a rotating carousel of updates is used to continually broadcast a series of update modules. In another embodiment, update broadcast start times are staggered in areas where geographical overlap will enable a digital tuner to receive signals from multiple sources at different times of the day. In another embodiment, a receiver agent may adjust to the use patterns of the television rather than requesting the use of the television for receiving updates at the same time each day.

In another aspect, the present invention relates to efficient methods and systems for storing update modules. In one embodiment, a database is used to store a carousel or queue of information relating to update modules. In another embodiment, XML is used to store and format the update modules.

In still another aspect, the present invention relates to efficient delivery networks for update modules for digital television. In one embodiment, a network consists of distributed, autonomous servers where each server is capable of running on its own, without communication to the centralized operation center, for a programmable period of time. In another embodiment a queue of update modules is created where modules are added and removed dynamically over time without stopping the broadcast of updates. In still another embodiment, a digital tuner in a broadcast server is used to automate the server installation, provide receipts of broadcast, and report network status.

In a fourth aspect, the present invention relates to consumer services that may be delivered via digital television networks. In one embodiment, advertisements may be displayed on a television screen along with volume and channel information in response to user input, such as when the channel and volume are changed. In another embodiment, a television channel may be displayed comprising information delivered via update modules.

In a fifth aspect, the present invention relates to a method of using broadcast bandwidth for updating firmware of digital televisions. In one embodiment, the method comprises: identifying a portion of unused bandwidth corresponding to a television station; selecting at least one update module, the update module comprising an update to firmware of a digital television; transmitting, via the unused bandwidth of the television station, the at least one update module; and receiving by a digital television, the at least one update module.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIGS. 1A and 1B are block diagrams of embodiments of a computing or network device useful as a device in a client-server network;

FIG. 2 is a diagram depicting one embodiment of a broadcast television network;

FIG. 3 is a diagram depicting one embodiment of a network for updating digital television firmware;

FIG. 4 is a block diagram depicting one embodiment of a carousel structure for storing and broadcasting a series of update modules;

FIG. 5 is a block diagram depicting in detail an embodiment of a structure for broadcasting a series of update modules;

FIG. 6 is a block diagram depicting two examples of utilization of an embodiment of a carousel structure for broadcasting a series of update modules;

FIG. 7 is a block diagram depicting one embodiment of bandwidth allocation for the broadcasting of update modules; and

FIG. 8 is a flow diagram of one embodiment of a method of using broadcast bandwidth for updating firmware of digital televisions.

### DETAILED DESCRIPTION OF THE INVENTION

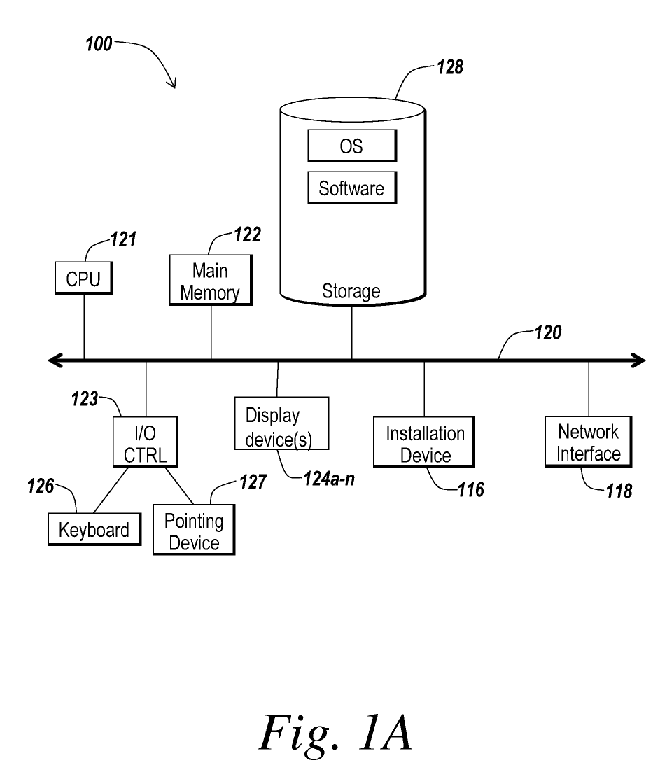

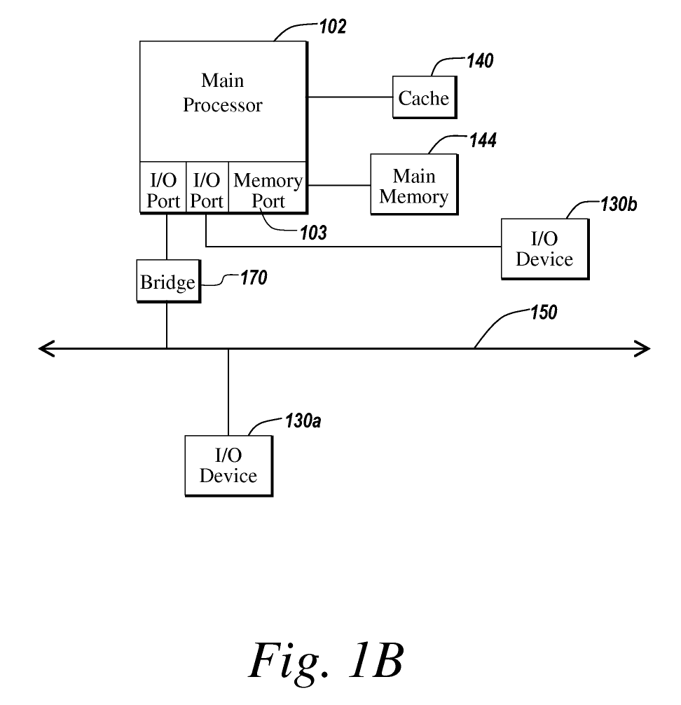

FIGS. 1A and 1B depict block diagrams of a typical computer 100 useful as client computing devices and server computing devices. As shown in FIGS. 1A and 1B, each computer 100 includes a central processing unit 102, and a main memory unit 104. Each computer 100 may also include other optional elements, such as one or more input/output devices 130a-130-b (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 1A, the processor 102 communicates with main memory 104 via a system bus 120 (described in more detail below). FIG. 1B depicts an embodiment of a computer system 100 in which the processor communicates directly with main memory 104 via a memory port. For example, in FIG. 1B the main memory 104 may be DRDRAM.

FIGS. 1A and 1B depict embodiments in which the main processor 102 communicates directly with cache memory 140 via a secondary bus, sometimes referred to as a “backside” bus. In other embodiments, the main processor 102 communicates with cache memory 140 using the system bus 120. Cache memory 140 typically has a faster response time than main memory 104 and is typically provided by SRAM, BSRAM, or EDRAM.

In the embodiment shown in FIG. 1A, the processor 102 communicates with various I/O devices 130 via a local system bus 120. Various busses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 102 may use an Advanced Graphics Port (AGP) to communicate with the display. FIG. 1B depicts an embodiment of a computer system 100 in which the main processor 102 communicates directly with I/O device 130b via HyperTransport, Rapid I/O, or InfiniBand. FIG. 1B also depicts an embodiment in which local busses and direct communication are mixed: the processor 102 communicates with I/O device 130a using a local interconnect bus while communicating with I/O device 130b directly.

A wide variety of I/O devices 130 may be present in the computer system 100. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 130 may be a bridge between the system bus 120 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 1A and FIG. 1B typically operate under the control of operating systems, which control scheduling of tasks and access to system resources. Typical operating systems include: MICROSOFT WINDOWS operating systems, such as WINDOWS XP and WINDOWS XP Embedded, both manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, California. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, California; or the Toshiba PocketPC e405, manufactured by Toshiba America, Inc. of New York, N.Y. In still other embodiments, the mobile device is a combination PDA/telephone device such as the Treo 180, Treo 270, Treo 600, Treo 650, or the Treo 700, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical mobile device may comprise many of the elements described above in FIGS. 1A and 1B, including the processor 102 and the main memory 104.

In some embodiments, the device 100 may comprise a digital television. A digital television may comprise any device capable of receiving a digital signal and outputting a visual display signal. In some embodiments, digital televisions may also comprise functionality for receiving analog transmissions. Digital televisions may comprise functionality for receiving transmissions via any digital network, including IP networks, terrestrial networks, satellite networks, and cable networks. A digital television output display signal may comprise any display standard, including Standard Definition (SD), High Definition (HD), or Enhanced Definition (ED). In some embodiments a digital television may include a display element, such as a screen or projector. In other embodiments, a digital television may comprise an appliance receives digital television signals and output a video display signal to be displayed by another device. Examples of appliances which may comprise a digital television include cable boxes, tuners, PVRs, VCRs, and DVD players. In other embodiments, a digital television may comprise a personal computer which receives digital television signals.

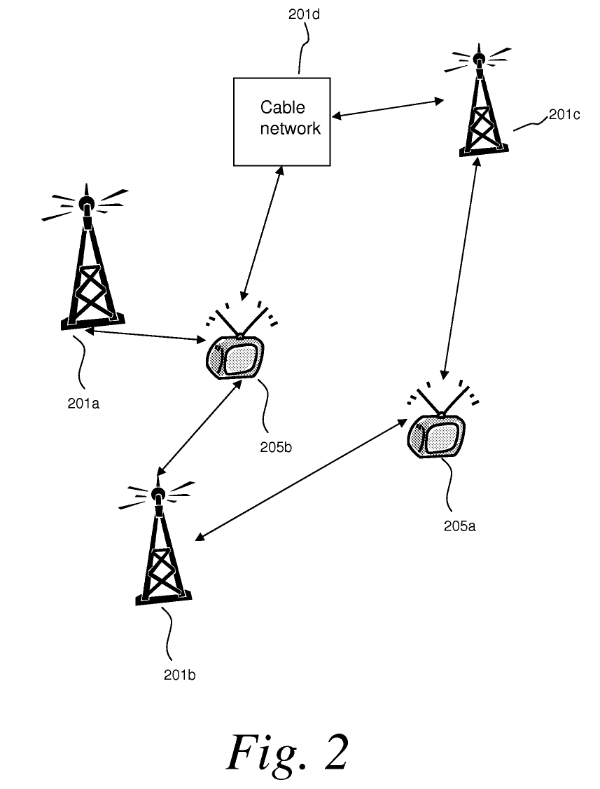

Referring now to FIG. 2, a diagram depicting one embodiment of a broadcast television network is shown. In brief overview, a number of broadcasters 201a, 201b, 201c, and 201d (generally referred to as 201), transmit broadcast signals either over airwaves or via wired networks to a number of digital televisions 205a, 205b (generally referred to as 205).

Still referring to FIG. 2, now in greater detail, in the embodiment shown, a television 205 may receive a broadcast signal from a plurality of broadcasters 201. In other embodiments, a television 205 may receive only one broadcast signal. In the embodiment shown, a television 205 may receive broadcast signals via airwaves, wired networks or both. A broadcaster 201 may transmit signals via airwaves, cable networks, satellite transmission, or any other means of delivering a signal. A cable network may comprise both one-way or two-way cable networks, and any associated protocols. In some embodiments, the signals transmitted by a broadcaster 201 may comprise any protocol relating to the transmission of digital television signals, including ATSC A/97, A/90, DSM-CC, SCTE 28, IPTV, IGMP, RSTV, DVB, and ISDB. In other embodiments, the signals may comprise any protocol relating to the transmission of analog television signals, including PAL, SECAM, and NTSC. In other embodiments the signals transmitted and received may comprise any protocol capable of carrying information, including SSL, HTML, XML, RDP, ICA, FTP, HTTP, TCP, IP, UDP, IPX, SPX, AMPS, TDMA, CDMA, GSM, GPRS UMTS, NetBIOS, NetBEUI, SMB, SMTP, Ethernet, ARCNET, Fiber Distributed Data Interface (FDDI), RS232, IEEE 802.11, IEEE 802.11a, IEE 802.11b, IEEE 802.11g and direct asynchronous connections, or any combination thereof.

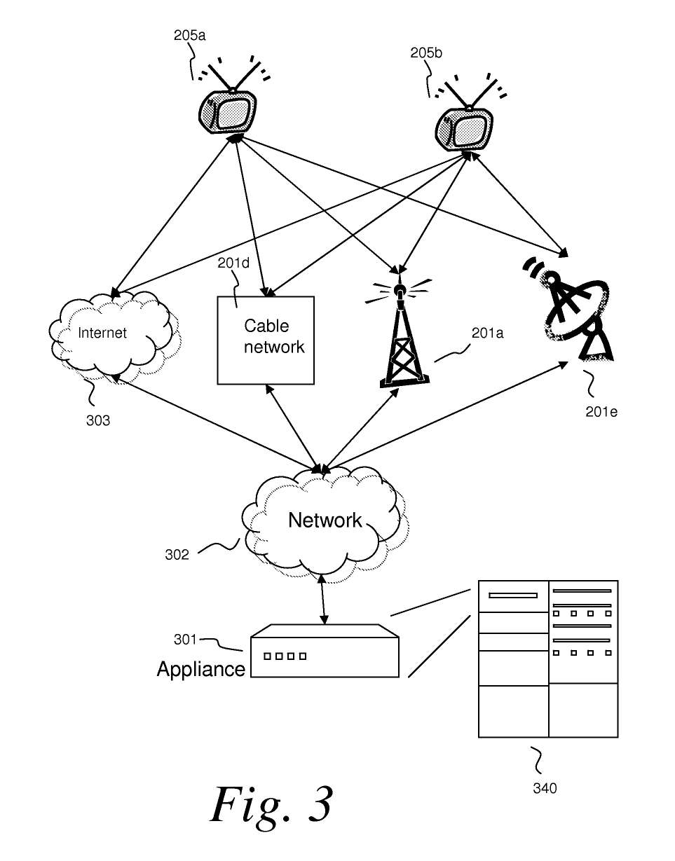

Referring now to FIG. 3, a diagram depicting one embodiment of a network for updating digital television firmware is shown. In brief overview, an appliance 301 is connected via a network 302 to the internet 303, a satellite network 201e, a broadcaster 201a, and a cable network 201d. In the embodiment shown, the resources 303, 201e, 201a, 201d are in turn connected to a plurality of digital televisions 205. In other embodiments, the appliance may be connected with any computing, transmitting, or receiving device, including a server, database, networks, wireless device, broadcaster 201, television 205, PVR, DVD reader/writer/player, or radio. The appliance 301 may also be mountable in a rack 340 with other appliances performing similar or dissimilar functions. In some embodiments, the appliance 301 may correspond to an appliance in a network operations center, such as a central server or other appliance.

Still referring to FIG. 3, now in greater detail, an appliance 301, is connected to a plurality of resources via a network 302. Said connections may be unidirectional or bidirectional, and may comprise any protocol used for communication between devices, including any protocols discussed herein. The network 302 may comprise any of the computing devices 100 previously discussed, either alone, or in combination, and may utilize any protocol used to communicate among or within computing devices. In some embodiments, the appliance 301 may be directly connected to any of the resources 303, 203, 201, 320 shown either by cable or radio transmission. In some embodiments, the appliance 301 may be connected to a plurality of resources 303, 203, 201, 320 via a plurality of networks.

In the embodiment shown, the appliance 301 may comprise any computing device 100. In the embodiment shown, the appliance comprises functionality for storing and transmitting update modules. Said update modules may comprise updates to digital television firmware. An update module may comprise any means of updating digital television firmware. In some embodiments, an update module may be an executable file intended for execution on a television 205. In other embodiments, an update module may comprise a configuration file. In still other embodiments, an update module may comprise content intended to be viewed by a user. An update module may comprise any programming language, file type, or file protocol. In one embodiment, an update module may comprise a single file, in another embodiment, and update module may comprise a plurality of files. In still other embodiments, an update module may comprise a plurality of modules or sub-modules.

In some embodiments, update modules may correspond to a particular brand or model of television 205. In one embodiment, an update module may update or modify any function, display, feature, or service of a given brand or model of television 205. In another embodiment, an update module may fix a bug or improve performance of a given television 205. In still another embodiment, an update module may provide functionality for viewing menus or displays relating to program selection 201. In one embodiment an update module may provide functionality for diagnosing problems or difficulties with the television 205. In another embodiment, an update module may provide or enhance viewing features including channel and program selection, picture-in-picture, and display definition. In another embodiment, an update module may provide or enhance features including recording and playback of content. In still another embodiment, an update module may comprise functionality for viewing content protected by any DRM functionality, including HDCP, ROM-Mark, AACS, BD+, and CSS.

In other embodiments, update modules may correspond to a particular broadcaster or broadcasters 201. In one embodiment, an update module may provide compatibility with a given feature, service, or function provided by a broadcaster. In another embodiment, the update module may provide interactive functionality for communicating with a given broadcaster 201. For example, an update module may provide functionality for ordering a given television or movie to be displayed. Or, for example, an update module may provide functionality for displaying or interacting with a user's subscription or billing information for a given broadcaster 201. In still another embodiment, an update module may provide functionality for viewing menus or displays relating to program selection corresponding to a given broadcaster 201.

In still other embodiments, an update module may correspond to a given service. In one embodiment, an update module may comprise content such as advertising, news, or local events. In one embodiment, the update module may comprise functionality for displaying said content in response to a user action such as changing the volume or channel of the television. In another embodiment, an update module may comprise functionality for displaying said content as a separate channel. For example, an update module or series of update modules may comprise functionality for displaying a “channel 0” when the user first turns on their digital television, or first activates a digital set-top box. Said channel may provide local news, and may also comprise information relating to television services received by the given user. In one embodiment, this channel may take the form of a home page, which allows users to select information to view from such information as local news, weather, sports, and television services.

In another embodiment, an update module may comprise scheduling information relating to current or future update modules. The scheduling information may comprise any information relating to the delivery of an update module, including the time of day and length of the update. In other embodiments, scheduling information relating to current or future update modules may be delivered via a separate information stream. In still another embodiment, an update module may provide functionality for collecting information from the digital television. In one embodiment, an update module might comprise functionality for transmitting to a central server information corresponding to the programs and advertisements viewed on a given television.

In other embodiments, an update module may comprise functionality for efficiently receiving current or future update modules. In other embodiments, said functionality may be delivered via a separate information stream. In one embodiment, an update module may comprise a schedule of future updates. In another embodiment, an update module may comprise functionality for decompressing future update modules. In still another embodiment, an update module may comprise a field specifying the type of encryption used on an update module. Any encryption or security techniques may be used in conjunction with the update modules including without limitation message digests and digital signatures. For example, an update module or one or more fields or sub modules of an update module may be encrypted with RSA encryption and triple-DES to prevent tampering and/or unauthorized access. In some embodiments, each brand or model of television may possess unique encryption or decryption keys for deciphering update modules.

In some embodiments, the appliance 301 may transmit update modules to digital televisions via any of the connections shown. In some embodiments, the update modules may be delivered to individual televisions via a broadcaster 201. In other embodiment, the update modules may be delivered to individual televisions via a cable network 203, or a satellite network 320. In still other embodiments, the update modules may be delivered to individual televisions via the internet 303 or another computing network. For example, a digital television may periodically connect to a specified IP address to check if any updates are available for the particular make or model of the television. If an update is available, the update may then be transmitted to the television.

In some embodiments, update modules are stored on the appliance 301 for transmitting. In other embodiments, update modules may be stored on any separate computing device, including a database or file server. In some embodiments, a single appliance 301 may transmit all updates to a given source or sources. In other embodiments, a plurality of appliances 301 may transmit updates to a given source or sources.

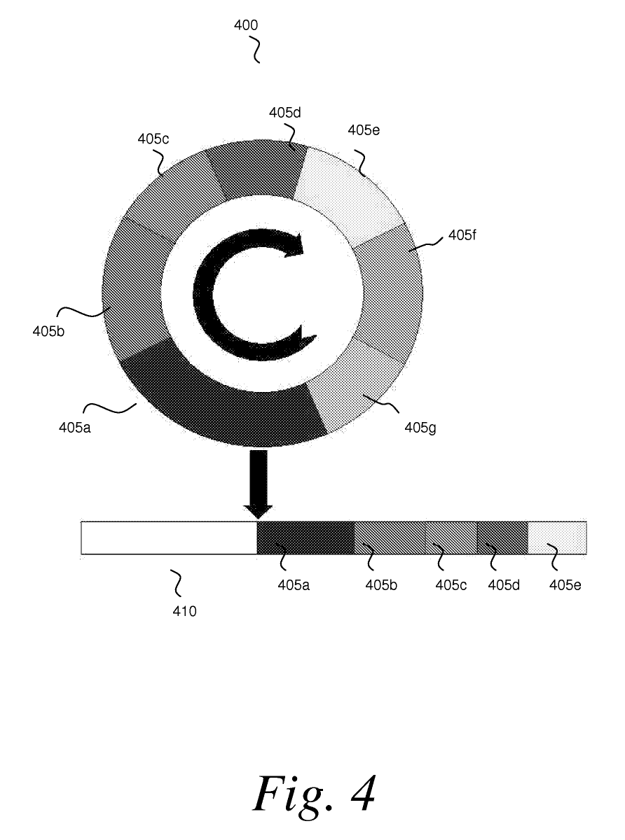

Update modules may be transmitted by any protocol used to communicate among or within devices. In some embodiments, update modules may be transmitted along with data corresponding to a given television program or channel. In one embodiment, update modules may be transmitted in bandwidth reserved for public television stations. In some embodiments, update modules may be broadcast at given times. In other embodiments update modules may be broadcast continuously. In some embodiments, update modules may be broadcast according to a carousel structure as described herein in FIG. 4. In other embodiments, update modules may be broadcast according to a queue structure. In still other embodiments, update modules may be transmitted using the “UpdateTV” protocol described herein. In some embodiments a single update module may be transmitted multiple times.

In some embodiments, a given update module may be transmitted at the same time across a plurality of networks. In other embodiments, a given update module may be transmitted at staggered times across a plurality of networks. For example, referring back to FIG. 2, a television 205a receives signals from a plurality of networks 201a, 201b, and 201c. A broadcaster 201a may begin transmitting an update module targeted for television 205a's at 5:00 AM, while broadcaster 201b may begin transmitting an update module targeted for consumer 205a's television at 1:00 PM. In some embodiments, said differing transmission times may be chosen to reflect demographic research. For example, if television 205a could only receive updates when the television was not currently in use, broadcasting of update modules may be staggered to generate a higher probability that at least one update module would be successfully received. For example, if statistics showed that a given consumer is very unlikely to use a television at both 5:00 AM and at 1:00 PM, update module transmitting might be scheduled accordingly.

In some embodiments, the appliance may receive update modules from any of the resources shown 303, 203, 201, 320. In some embodiments, update modules may be transmitted to the appliance via the internet 303, or a satellite network 320. In other embodiments the update modules may be transmitted to the appliance via a broadcaster 201 or a cable network 203. In some embodiments, a single appliance 301 may receive all updates from a given source or sources. In other embodiments, a plurality of appliances 301 may receive updates from a given source or sources.

In some embodiments, a plurality of appliances 301 may be installed in a plurality of geographic regions. In one embodiment, each of the plurality of appliances 301 would be responsible for transmitting update modules to each of the broadcasters in its given region. In another embodiment, the appliances 301 may be installed at local broadcast facilities 301. For example, one or more appliances 301 may be installed at a plurality of PBS broadcasting affiliates throughout the country.

Referring now to FIG. 4, a block diagram depicting one embodiment of a carousel structure for storing and broadcasting a series of update segments is shown. In brief overview, a plurality of update segments 405a, 405b, 405c, 405d, 405e, 405f, 405g (collectively 405) are stored in a carousel structure 400. The segments are then transmitted in a data stream 410 corresponding to the order of the segments 405 in the carousel 400.

Still referring to FIG. 4, now in greater detail, a carousel structure 400 stores a plurality of update segments 405. A carousel structure may transmit each of a series of updates 405, and after transmitting the last update 405 of the series, the carousel may begin transmitting the series over again. A carousel structure 400 may comprise any known means for implementing a circular data structure, including an array, linked list, tree, heap, or table. In some embodiments, blocks 405 may be added or removed from a carousel structure 400 while the carousel is active. In some embodiments a queue of segments 405 may be used to successively add modules 405 to a carousel structure.

In one embodiment, a carousel 400 may have a fixed cycle time. For example, a carousel 400 may be set to transmit all segments 405 in the carousel 400 within 4 days. In other embodiments, a carousel may have a fixed number of segments. In still other embodiments, a carousel may have a fixed total size of data.

In some embodiments, an appliance 301 may comprise a carousel structure for broadcasting updates. In other embodiments, an appliance may comprise multiple carousel structures. In some embodiments, a plurality of appliances may comprise carousel structures with synchronized broadcast times. For example, an appliance transmitting a data stream to a broadcaster 201a may comprise a carousel structure set to begin a series of update segments at 12:00 AM on a given day, while another appliance 301 transmitting to a second broadcaster 201c may comprise a carousel structure set to begin said series of update segments at 6:00 AM.

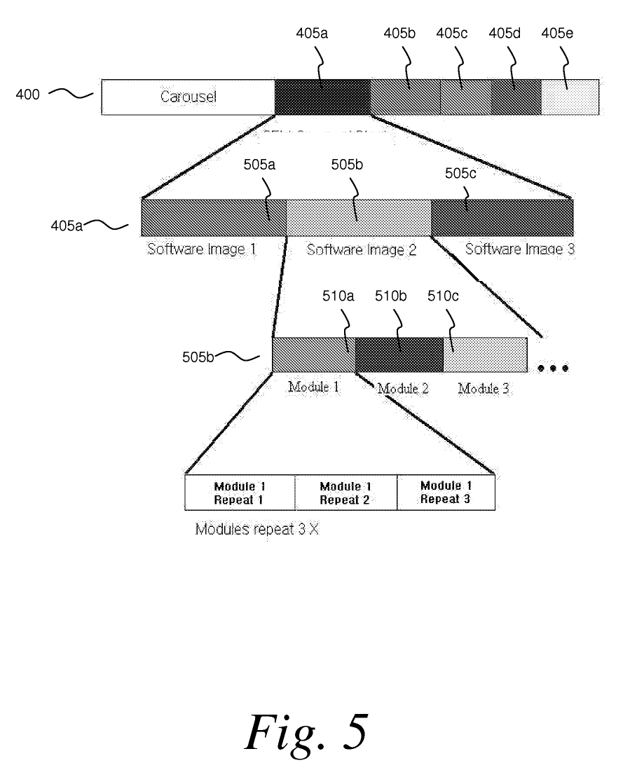

Referring now to FIG. 5, a block diagram depicting in further detail an embodiment of a structure for storing and broadcasting a series of update segments. In brief overview, a carousel structure 400 stores a number of update segments 405. Each update segment may comprise one or more software images 505a, 505b, 505c (generally referred to as 505). Each software image 505 may in turn comprise a number of modules 510a, 510b, 510c (generally referred to as 510). A given module may be repeated a given number of times within a given software image.

Still referring to FIG. 5, now in greater detail, a carousel structure stores a number of update segments 405. Said update segments may comprise any information or functionality as described herein. In some embodiments, each update segment may correspond to a given manufacturer of digital televisions. In other embodiments, each update segment may correspond to a given brand or model of digital televisions. In some embodiments, a single carousel may comprise segments corresponding to a plurality of digital television manufacturers. In other embodiments, a single carousel may comprise segments corresponding to a plurality of digital television brands or models.

Each update segment 405 may comprise a number of software images 505. In some embodiments, each software image may correspond to a given brand or model of digital television. In other embodiments each software image may correspond to a geographic region.

Each software image may comprise a number of modules 510. In one embodiment, each module 510 may correspond to a discrete update for a given brand or model of digital television. In other embodiments, each module 510 may correspond to a set of updates made available on a given date.

Each module 510 may be repeated a given number of times. In one embodiment, each module 510 is repeated three times in a given software image. In one embodiment, a module may corresponds to a discrete update for a given brand or model of digital television. In other embodiments, each module 510 may correspond to a set of updates made available on a given date. Said modules may comprise any content or functionality previously described herein with respect to update modules.

In some embodiments, a module may be broken into a number of sub-modules for transmission. These sub-modules may be any size, and may contain any portion of the update module. In one embodiment, each sub-module may contain error detecting or error-correction mechanisms, including without limitation checksums, digital signatures, and CRCs. In some embodiments, a digital television may have the capability to store individual sub-modules and discard individual sub-modules in the event of corruption in the transmission. This capability may be used to increase the reliability of a delivery channel, such that a given digital television may be able to assemble a complete, uncorrupted update module from a number of transmissions of an update module, where one or more sub-modules was corrupted in each transmission. For example, a 10 MB update module may be broken into 5 2 MB sub-modules for transmission. Upon receiving each of the sub-modules, a television may check to see that the sub-module has been properly received, and store the properly received sub-modules. In the event that a sub-module is corrupted, the television may discard the corrupted module, and wait for the next transmission of that sub-module to assemble the complete update module.

In other embodiments, the update modules 405, software images 505, modules 510, and modules 515 may be stored and transmitted along any other content, overhead, headers, protocols, or encapsulations.

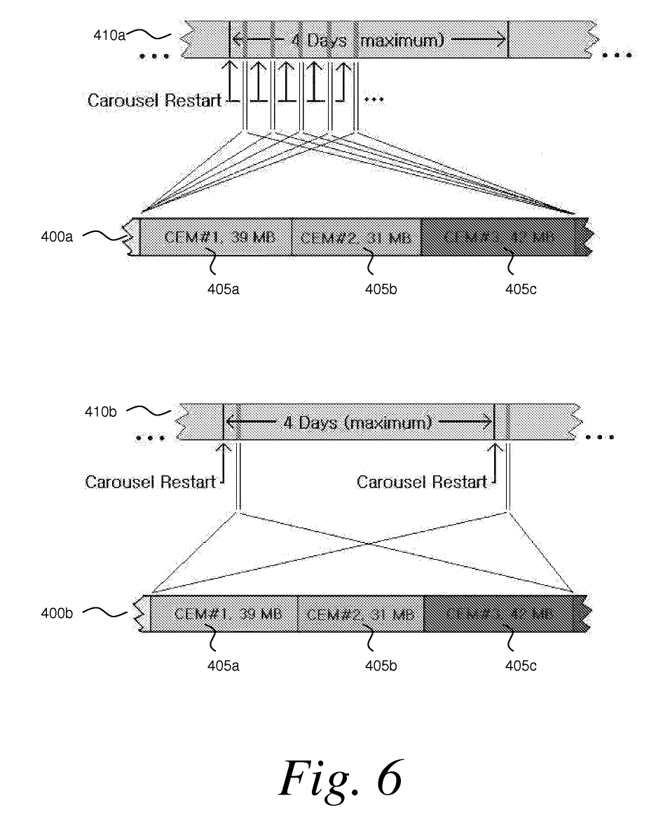

Referring now to FIG. 6, a block diagram depicting two examples of utilization of an embodiment of a carousel structure for storing and broadcasting a series of update modules is shown. In brief overview, two carousel structures 400a, 400b (collectively 400) comprise a series of update modules 405. The carousel structures 400 are each used to generate a data stream 410a, 410b (collectively 410). The data streams 410 each repeat after a given time interval.

Still referring to FIG. 6, now in greater detail, in the first example, a carousel structure 400a is used to generate a data stream 410a. In the embodiment shown, all the update modules 405 in the carousel 400a are broadcast in a period of time less than 4 days. In the embodiment shown, the data stream 410a repeats a number of times over the course of the 4-day period shown.

In the second example, a carousel structure 400b is used to generate a data stream 410b. In the embodiment shown, all the update modules 405 in the carousel 400b are broadcast in a period of time of 4 days. In the embodiment shown, the data stream 410a repeats at the end of the 4-day period shown.

In other embodiments, a carousel structure 400, or a data stream 410 may repeat after any given interval of time. In some embodiments, update modules 405 may be added or removed before, after, or during a given time interval.

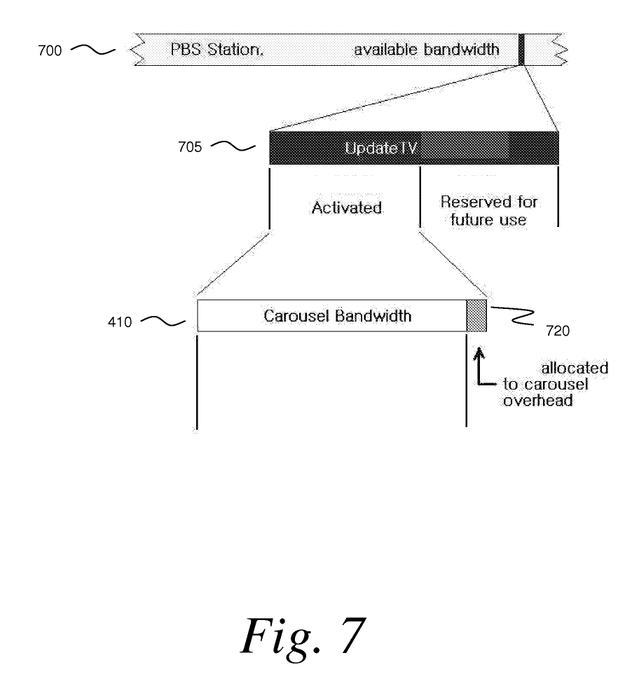

Referring now to FIG. 7, a block diagram depicting one embodiment of bandwidth allocation for the broadcasting of update modules is shown. In brief overview, a television station's broadcast bandwidth 700 is shown. A segment 705 of the bandwidth 700 is assigned to digital television functions. Portions of the segment 705 are either active or reserved for future use. In the embodiment shown, the activated portion of the segment 705 is used to transmit a data stream 410 from a carousel 400 of update modules 405.

Still referring to FIG. 7, now in greater detail, a television station's broadcast bandwidth 700 is shown. The television station may comprise any television station, signal, or protocol. In one embodiment, the television station may correspond to a public access channel. In another embodiment, the television station may correspond to a PBS broadcaster or affiliate. The bandwidth 700 may be divided according to any protocol or multiplexing algorithm. In some embodiments the bandwidth 700 may be segmented according to time. In another embodiment, the bandwidth may be segmented according to frequency.

In the embodiment shown, one segment 705 of the bandwidth 700 is used for transmitting material relating to digital televisions, or digital television services. The segment 705 may comprise any portion, segment, or percentage of the bandwidth 700. In the embodiment shown, a portion of the segment may be active while another portion may be reserved for future use.

In the embodiment shown, the activated portion of the segment is used to transmit a data stream 410 corresponding to a carousel 400. In other embodiments, a plurality of carousels may simultaneously transmit over a given available bandwidth. A portion 720 of the data stream 410 may be allocated for carousel overhead. The carousel overhead may comprise any information relating to the operation of the carousel, including scheduling information, file sizes, and error-checking.

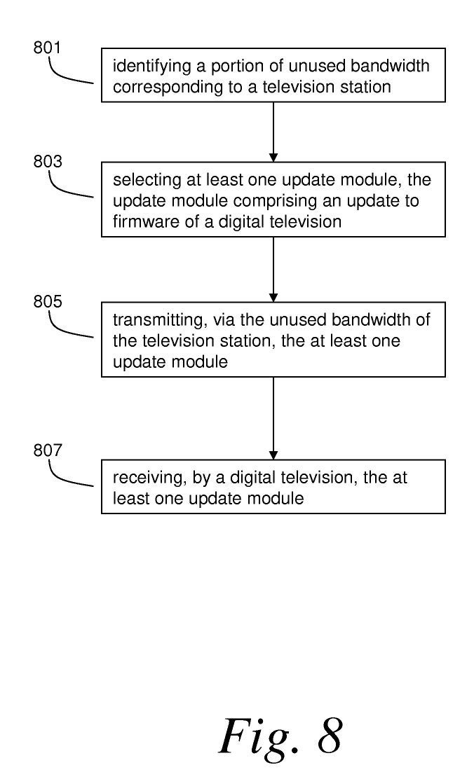

Referring now to FIG. 8, one embodiment of a method of using broadcast bandwidth for updating firmware of digital televisions is shown. In brief overview, the method comprises: identifying a portion of unused bandwidth corresponding to a television station (step 801); selecting at least one update module, the update module comprising an update to firmware of a digital television (step 803); transmitting, via the unused bandwidth of the television station, the at least one update module (step 805); and receiving by a digital television, the at least one update module (step 807).

Still referring to FIG. 8, now in greater detail, unused bandwidth of a television station may be identified in any manner, and at any time (step 801). In some embodiments, the television station may be a public television station, such as PBS. In other embodiments, the television station may be a commercial television station. In still other embodiments, the television station may be a private television station, such as a closed-circuit television station, or a television station run at a test facility.

The unused bandwidth may be identified in any manner. In some embodiments, unused bandwidth may be identified in one or more of frequency, time, amplitude, or coding domains. The unused bandwidth may be identified by any entity, including without limitation a broadcast station, an appliance 301, or a central server. In some embodiments, unused bandwidth may be scheduled and/or identified in advance. In other embodiments, unused bandwidth may be identified dynamically and/or on a just-in-time basis.

An update module comprising an update to firmware of a digital television may be selected in any manner (step 803). In some embodiments, the at least one update module may be selected by an appliance 301. In these embodiments, the appliance 301 may select an update module the appliance has received from a central server or from a digital television manufacturer. In some embodiments, the at least one update module may be selected by an appliance 301 and then transmitted to a broadcast station for retransmission to consumers.

The at least one update module may be selected by any algorithm or process. In some embodiments, the update module may be selected from a queue or carousel. In other embodiments, the update module may be selected on the basis of size, transmission time, corresponding television brand, corresponding television model, recentness of the update module, or any other factor.

The at least one update module may be transmitted, via the unused bandwidth of the television station in any manner (step 805). In one example, a digital television manufacturer may send a firmware update to a central server. The central server may then package the firmware update into an update module, such as, for example, packaging it into sub modules and adding identifying information. The central server may then transmit the update module to a number of appliances 301 which may then add the update module into a sequence of update modules awaiting transmission. At the designated time in the sequence, an appliance 301 may then select the update module and transmit the update module to a television broadcaster. The television broadcaster may then transmit the update module out via a broadcast.

In another example, a digital television manufacturer may maintain a number of televisions internally for testing purposes. These televisions may be connected to an appliance 301. If the manufacturer wants to distribute an update to the firmware of each of the televisions, the manufacturer may upload the firmware update to the appliance 301. The appliance 301 may then package the firmware update into an update module, and then transmit the update module to each of the digital televisions. This transmission may be performed via any television station, including any closed circuit or private stations maintained internally by the manufacturer.

An update module may be received by a digital television in any manner (step 807). A digital television may also use any means and techniques to identify whether an update module corresponds to the digital television and should therefore be installed. In some embodiments, a digital television may receive a schedule of when future update modules corresponding to the digital television will arrive. In other embodiments, a digital television may identify an update module by a serial number, key, or other identifier.

The following example section describes one embodiment of a protocol, referred to as “UpdateTV,” which may be used in the transmission and reception of update modules for digital televisions. The details of the protocol are one example, one of ordinary skill in the art will recognize that many additions, subtractions, and modifications may be made to the example below.

### Example A/97 Implementation Details

The UpdateTV network broadcasts may be based on the DSM-CC data carousel fundamentals and the standardized protocols defined in A/90 and A/97.

The UpdateTV network may be completely compatible with these specifications. However, the UpdateTV implementation may also provide network identification, improve security, conserve bandwidth, and to provide the expansion capabilities required in supporting a large number of manufacturers with a single carousel.

### Download Server Initiate Message (DSI)

The DSI message announces network compatibility and manufacturer support information. A/90 specifies the use of the Group Information Indication (GII) field which occupies the privateDataByte section in the DSI message.

Within the GII, there are three fields that are left to be defined by the implementer. These are the groupCompatibility field, the groupInfoByte field, and the groupsInfoPrivateDataByte field. A/97 further restricts the data such that the groupCompatibilty field will contain the compatibilityDescriptor and the groupInfoByte field shall contain the descriptorStructure.

The following sections discuss the UpdateTV usage for these fields in the DSI.

A/90 compatibilityDescriptor within the GII

The UpdateTV implementation reduces the role of the A/90 compatibilityDescriptor in favor of enhancing the content of the flexible fields in the DII. The DSI is size limited and only one DSI is allowed per carousel.

### UpdateTV Use

In the interest of preserving bits in the DSI, UpdateTV uses the first two fields of the compatibilityDescriptor: Organization Unique Identifier (OUI) and Model.

To do this, we treat the Model field of the compatibilityDescriptor as a Model Group. The Model Group is used to identify a group of receivers that share a common code base or functionality and hence are signaled by the same DII.

Since the manufacturer defines each Model Group, it can be used by a manufacturer to signal to a receiver that the module payload is shared by a number of hardware models. Additional signaling to complete this functionality is provided in the DII.

### UpdateTV Restrictions

The UpdateTV Implementation of the A/97 compatibilityDescriptor imposes the following restrictions:
1. Receivers should recognize and parse only the first descriptor that is defined by A/97 to be of descriptorType 0x01 (system hardware).
2. Receivers should ignore the version field of this descriptor.
3. Receivers should ignore the subDescriptor field of this descriptor.
4. A Model Group value of 0xffff signifies compatibility with all Model Groups of that OUI.
   groupInfoByte descriptorStructure Field

The groupInfoByte field is defined by A/90 and A/97 to contain a descriptor structure.

The UpdateTV network does not use the GII groupInfoByte field.

A/90 groupsInfoPrivateDataByte Field

The groupsInfoPrivateDataByte field is defined by A/90 to contain private data. The format of private data is left to the implementer.

### UpdateTV Private Descriptor Format

The UpdateTV network fills this private data section using a descriptor format. Each descriptor in the groupsInfoPrivateDataByte section of the DSI contains the following format:

| | | |
|---|---|---|
| Syntax | Number of Bits | Format |

updateTVPrivateDataDescriptor
{

| | | |
|---|---|---|
| descriptorTag | 8 | uimsbf* |
| descriptorLength | 8 | uimsbf |
| for ( i = 0; i < N; i++ ) | | |
| { | | |

| | | |
|---|---|---|
| descriptorData | 8 | uimsbf |

}

}

*unsigned integer, most significant bit first

Two descriptors are assigned, one for Network Identification (tag number 0) and one for a copy of the System Time Table (tag number 3).

### Network Identification Descriptor

The receiver should validate a complete match with the Network Identification field when scanning for compatible carousels. This descriptor identifies the carousel data as being broadcast by the UpdateTV Network.

The Network Identification descriptor must appear last in the groupsInfoPrivateDataByte field. The tag value of this descriptor is 0x00.

| | | |
|---|---|---|
| Syntax | Number of Bits | Format |

updateTVNetworkIdDescriptor
{

| | | |
|---|---|---|
| descriptorTag (0x00) | 8 | uimsbf |
| descriptorLength | 8 | uimsbf |
| networkID | 16 | uimsbf |
| networkVersion | 16 | uimsbf |

}

### Broadcast Time Descriptor

The time descriptor carries a copy of the STT from the original broadcast signal (see A65B section 6.1).

The copy of the STT data is provided because the STT from the original broadcast signal may be missing or replaced when the data carousel is rebroadcast. The STT format time is used when evaluating the schedule descriptors in the DII. The data in this descriptor is identical to the data provided in the STT. The tag value of this descriptor is 0x03.

| | | |
|---|---|---|
| Syntax | Number of Bits | Format |

UpdateTVSystemTimeDescriptor
{

| | | |
|---|---|---|
| descriptorTag (0x03) | 8 | uimsbf |
| descriptorLength | 8 | uimsbf |
| protocolVersion | 8 | uimsbf |
| systemTime | 32 | uimsbf |
| gpsUtcOffset | 8 | uimsbf |
| dsStatus | 1 | |
| dsReserved | 2 | |
| dsDayOfMonth | 5 | uimsbf |
| dsHour | 8 | uimsbf |

}

### Example UpdateTV Private Descriptor

Version 1 of the UpdateTV Server will format the data as follows.

groupsInfoPrivateDataLength 0x0010
groupsInfoPrivateDataByte
{

descriptorTag 0x03
descriptorLength 0x08

(8 bytes in same format as STT)

descriptorTag 0x00
descriptorLength 0x04

networkId 0x0BDC
networkVersion 0x0001

}

Download Information Indication Message (DII)

The DII provides information each module's compatibility beyond the OUI/Model Group pair as specified in the DSI.

The A/90 specification allows implementer definition of the moduleVersion, moduleInfoByte, and privateDataByte fields.

This use of these fields is further restricted by A/97 which uses the moduleInfoByte field to contain instances of the moduleInfoDescriptor and/or scheduleDescriptor while the privateDataByte field contains a descriptorStructure.

The following additional restrictions are required in the UpdateTV implementation.
1. The moduleInfoByte descriptorStructure shall contain at least one moduleInfoDescriptor and at least one scheduleDescriptor.
2. The privateDataByte field is not used and hence should be ignored by receivers.
3. The moduleVersion field shall contain a version number specified by the manufacturer where greater numbers represent newer versions.

The module information loop of this descriptor (moduleld, moduleSize, . . . ) contains an inner loop of moduleInfoBytes which is limited in length to 256 bytes. This descriptor loop contains both moduleInfoDescriptors and scheduleDescriptors. The moduleInfoDescriptor contains two inner loops, nameBytes and privateModuleBytes.

If not used efficiently, these descriptors and inner loops may strain the 256 byte limit of moduleInfoByte. To avoid situation, UpdateTV conservatively defines the uses for these fields.

### A/97 Module Info Descriptor

The Module Info Descriptor, as defined by A/97, allows implementer flexibility with the nameByte field and the privateModuleByte field.

The UpdateTV restrictions on these fields is defined below.

A/97 nameByte Field

The nameLength value of the moduleInfoDescriptor shall not exceed 16. While limited in size, the use of the nameByte field is not further restricted by this document.

When a receiver is capable of accepting multiple types of modules, the nameByte field may be used to communicate the purpose of the module to the receiver. For example when a large image is partitioned into multiple smaller, more manageable, modules this field may be used to specify the purpose and position of each module (for example “sw1of6.ROM”).

A/97 privateModuleByte Field

This field is used to specify the UpdateTV compatibility descriptor and module priority.

The first 8 bits shall contain the modulePriority byte. The modulePriority byte in the privateModuleByte field shall be followed by the descriptorStructure as follows. Only UpdateTV defined descriptors, as defined in this document, may be used in this descriptorStructure.

| Syntax | Number of Bits | Format |
|---|---|---|
| modulePriority | 8 | uimsbf |
| descriptorStructure | | |
| { | | |

for ( i = 0; i < N; i++ )
{

| | | |
|---|---|---|
| descriptor( ) | 8 | uimsbf |

}

}

One descriptor has been defined for this structure, the updateTVCompatibilityDescriptor.

modulePriority—This field is used to specify a module's download priority. If two or more modules are available for download in the same time period, the one with the lowest numbered priority is chosen for download.

### UpdateTV Compatibility Descriptor

The UpdateTV Compatibility Descriptor lies in the privateModuleByte field, as specified above. Each descriptor contains a range of hardware models and software versions.

| | | |
|---|---|---|
| Syntax | Number of Bits | Format |

updateTVCompatibilityDescriptor
{

| | | |
|---|---|---|
| descriptorTag | 8 | uimsbf |
| descriptorLength | 8 | uimsbf |
| for ( i = 0; i < N; i++ ) | | |
| { | | |

| | | |
|---|---|---|
| hardwareModelBegin | 8 | uimsbf |
| hardwareModelEnd | 8 | uimsbf |
| softwareVersionBegin | 8 | uimsbf |
| softwareVersionEnd | 8 | uimsbf |

}

}

descriptorTag—This field shall be set to 0x82.
descriptorLength—This field shall be set to the length in bytes in this descriptor following this field.
hardwareModelBegin—This field represents the beginning of a range of compatible hardwareModel values.
hardwareModelEnd—This field represents the end of a range of compatible hardwareModel values.
softwareVersionBegin—This field represents the beginning of a range of compatible softwareVersion values.
softwareVersionEnd—This field represents the end of a range of compatible softwareVersion values.

After first confirming compatibility with the DSI compatibility descriptor (OUI and Model Group), the receiver will inspect each hardwareModel range and softwareVersion range to validate compatibility with this module. Several UpdateTV Compatibility Descriptors may appear in the privateModuleByte field. If the module meets any of the compatibility descriptors, it is considered a candidate for download.

### UpdateTV Compatibility Descriptor

The UpdateTV Compatibility Descriptor allows for a powerful way to select modules from the carousel. There may be up to about 20 UpdateTV Compatibility structures per module (limited by the 255 byte limit of the privateModuleByte field.

The UpdateTV Network is designed to deliver TV system level software updates. The UpdateTV Network can also be used to distribute any other digital content.

### Hardware Model Range

The hardwareModelBegin and hardwareModelEnd fields are used to specify a range of hardware models that the module is compatible with. The hardware model values are scoped by the Model Group and OUI.

Compatibility is indicated if the receiver's hardware model value for that Model Group is greater than or equal to the value of the hardwareModelBegin field and less than or equal to the value of the hardwareModelEnd field. The receiver's hardware model does not change when the system level software is updated.

Unique hardware model values are assigned to each unique hardware platform in a Model Group. The hardware model value must be determined by looking at hardware registers or configuration. The hardware model must not be a value that is coded in the system level software.

### Software Model Range

The softwareVersionBegin and softwareVersionEnd fields are used to specify a range of software versions that the module is compatible with. The software version values are scoped by the Model Group and OUI.

Compatibility is indicated if the receiver's software version value is greater than or equal to the softwareVersionBegin field and less than or equal to the softwareVersionEnd field. The software version is incremented for each system level software release. The value for the software version should be a value that is set by running system level software.

### Example

A system level software image on the carousel is software version 4. This system level software is applicable for hardware models 0 to 2 running software versions 0 through 3, and hardware model 4 running software versions 2 through 3. The following descriptor shows two ranges of hardware model and software version.

updateTVCompatibilityDescriptor
{

descriptorTag 0x82
descriptorLength 0x08

hardwareModelBegin 0x00
hardwareModelEnd 0x02
softwareVersionBegin 0x00
softwareVersionEnd 0x03
hardwareModelBegin 0x04
hardwareModelEnd 0x04
softwareVersionBegin 0x02
softwareVersionEnd 0x03

}

Signaling the Download Data Service

The ATSC A/97 specification provides signaling of a DSM-CC data carousel. This specification signals the download data service through a Virtual Channel in the VCT of service_type 0x05.

The Virtual Channel is used to locate the PMT with the Program specified that includes a Program Element of stream_type 0x0B. This mechanism relies on the presence of the VCT to locate the proper PMT.

In order to ensure reliable signaling through various MPEG transports, the UpdateTV PMT MRD is added to the PSI data. This is provided as an alternative to the A/97 PSIP signaling when the VCT is not available. The UpdateTV SDK attempts to locate the DSM-CC data carousel through the mechanism detailed above. If a DSM-CC data carousel is not located in this way, the UpdateTV SDK attempts to locate it by examining the Program Elements in each PMT signaled in the PAT for the presence of an UpdateTV MRD.

### UpdateTVMPEG-2 Registration Descriptor

The UpdateTV MRD is an MPEG-2 Registration Descriptor which may be found in the ES info descriptor loop within each Program Element.

| | | |
|---|---|---|
| Syntax | Number of Bits | Format |

updateTVRegistrationDescriptor
{

| | | |
|---|---|---|
| descriptorTag (0x05) | 8 | uimsbf |
| descriptorLength | 8 | uimsbf |
| formatIdentifier | 32 | uimsbf |

}

### Example UpdateTV MRD

updateTVRegistrationDescriptor
{

descriptorTag 0x05
descriptorLength 0x04

formatIdentifier “BDC0”

}

}

While various embodiments of the present invention have been described above, it should be understood that they have been presented by way of example only, and not limitation. Thus, it will be understood by those skilled in the relevant art(s) that various changes in form and details may be made therein without departing from the spirit and scope of the invention as defined by the appended claims.

We claim:

1. A method of using broadcast bandwidth for updating firmware of digital televisions, the method comprising:
(a) identifying a portion of unused bandwidth corresponding to a television station;
(b) selecting at least one update module, the update module comprising an update to firmware of a digital television; and
(c) transmitting, via the unused bandwidth of the television station, the at least one update module.

2. The method of claim 1, wherein step (a) comprises identifying a portion of unused bandwidth corresponding to a public television station.

3. The method of claim 1, wherein step (a) comprises identifying a portion of unused bandwidth corresponding to a commercial television station.

4. The method of claim 1, wherein step (a) comprises identifying a portion of unused bandwidth corresponding to a private television station.

5. The method of claim 1, wherein step (b) comprises selecting a plurality of update modules, each of the plurality of update modules comprising an update to firmware of a digital television.

6. The method of claim 1, wherein step (b) comprises (i) selecting a first update module comprising an update to firmware of a first brand of digital television and (ii) selecting a second update module comprising an update to firmware of a second brand of digital television.

7. The method of claim 1, wherein step (b) comprises (i) selecting a first update module comprising an update to firmware of a first model of digital television and (ii) selecting a second update module comprising an update to firmware of a second model of digital television.

8. The method of claim 1, wherein step (b) further comprises adding information to the update module, the information indicating a schedule for transmission of update modules.

9. The method of claim 1, wherein step (c) comprises transmitting the at least one update module in a sequence, wherein the sequence is periodically retransmitted.

10. The method of claim 9, wherein each update module of the at least one update module is repeated a predetermined number of times within the sequence.

11. The method of claim 9, wherein each update module of the at least one update module is transmitted for a set period of time within the sequence.

12. The method of claim 1, wherein step (c) comprises transmitting over airwaves, via the unused bandwidth of the television station, the at least one update module.

13. The method of claim 1, wherein step (c) comprises transmitting over cable, via the unused bandwidth of the television station, the at least one update module.

14. The method of claim 1, wherein step (c) comprises transmitting, via the unused bandwidth of the television station, the at least one update module, wherein the transmission is synchronized with a second transmission of update modules from a second source, the second transmission having an overlapping coverage area with the first transmission.

15. The method of claim 1, wherein step (c) further comprises synchronizing the transmitting with a second transmission of update modules from a second source, the second transmission having an overlapping coverage area.

16. The method of claim 1, wherein step (c) further comprises staggering the transmitting with a second transmission of update modules from a second source, the second transmission having an overlapping coverage area.

17. The method of claim 1, wherein step (c) comprises transmitting via the unused bandwidth of the television station, the at least one update module as a plurality of sub-modules.

18. The method of claim 17, further comprising:
(d) receiving, by a digital television, at least one intact sub-module;
(e) storing, by the digital television, the at least one intact sub-module;
(f) receiving, by the digital television, at least one corrupted sub-module;
(g) discarding, by the digital television, the at least one corrupted sub-module;
(h) receiving, by the digital television, a second transmission of the discarded at least one sub-module;
(i) assembling, by the digital television, the selected update module from the stored at least one intact sub-module and the received second transmission.

19. The method of claim 1, further comprising transmitting, via the unused bandwidth of the television station, information indicating the local time at a broadcaster.

20. A server system for using broadcast bandwidth for updating firmware of digital televisions, the system comprising:
a receiver which receives at least one update modules, each of the at least one update modules comprising an update to firmware of a digital television.
a storage element in communication with the receiver which stores a sequence of the at least one update modules; and
a transmitter in communication with the storage element which transmits, to at least one television broadcaster, the sequence of at least one update modules.

21. The system of claim 20, further comprising a processor which formats the stored sequence of the at least one update modules in a format suitable for transmission via the unused bandwidth of a television station.

22. The system of claim 20, wherein the receiver receives a first update module comprising an update to firmware of a first brand of digital television and receives a second update module comprising an update to firmware of a second brand of digital television.

23. The system of claim 20, wherein the receiver receives a first update module comprising an update to firmware of a first model of digital television and receives a second update module comprising an update to firmware of a second model of digital television.

24. The system of claim 20, wherein the receiver receives the at least one update module from a central server.

25. The system of claim 20, wherein the transmitter periodically retransmits the sequence.

26. The system of claim 25, wherein each update module of the at least one update module is repeated a predetermined number of times within the sequence.

27. The system of claim 25, wherein each update module of the at least one update module is transmitted for a predetermined amount of time within the sequence.

28. The system of claim 20, wherein the transmitter transmits, to at least one airwave broadcast station, the sequence of at least one update modules.

29. The system of claim 20, wherein the transmitter transmits, to at least one cable broadcast station, the sequence of at least one update modules.

30. The system of claim 20, wherein the transmission of the sequence is synchronized with a second transmitter, the second transmitter transmitting the sequence to a second broadcaster, wherein the second broadcaster and the at least one broadcaster have overlapping coverage areas.

31. The system of claim 20, wherein the transmission of the sequence is staggered with a second transmitter, the second transmitter transmitting the sequence to a second broadcaster, wherein the second broadcaster and the at least one broadcaster have overlapping coverage areas.

32. The system of claim 20, wherein the appliance transmits each of the at least one update modules as a plurality of sub-modules.

33. The system of claim 32, further comprising a digital television, which receives at least one intact sub-module; stores the at least one intact sub-module; receives at least one corrupted sub-module; discards the at least one corrupted sub-module; receives a second transmission of the discarded at least one sub-module; and assembles, by the digital television, an update module from the stored at least one intact sub-module and the received second transmission.
